(19) United States
(12) Patent Application Publication
(10) Pub. No.: US 2007/0241560 A1
(43) Pub. Date: Oct. 18, 2007

(54) Coaxial quick connector

(76) Inventor: David S. Malone, Attica, MI (US)

Correspondence Address: YOUNG & BASILE, P.C., 3001 WEST BIG BEAVER ROAD, SUITE 624, TROY, MI, 48084, US

(21) Appl. No.: 11/406,027

(22) Filed: Apr. 18, 2006

(51) Int. Cl. F16L 7/00; F16L 39/00

(52) U.S. Cl. 285/319; 285/123.1; 285/123.3; 285/23

(57) ABSTRACT

A fluid connector body having a throughbore carries an insert forming first and second flow paths through the body to fluidically couple first and second coaxial flow paths in a first endform to third and fourth coaxial flow paths in a second endform when both of the endforms are coupled to the body. A retainer latches the first endform to body. The sealed coupling of the first flow path in the first endform to the insert is concentrically within the second flow path through the body such that any liquid or vapor escaping from the sealed coupling is contained within the second flow path.

### BACKGROUND

The present invention relates, in general, to fluid flow systems in which conduits or tubular members are interconnected in fluid flow communication with fluid operative devices or other fluid conduits by means of releasable quick connectors.

Snap-fit or quick connectors are employed in a wide range of applications, particularly for joining fluid carrying conduits in automotive and industrial applications. In a typical quick connector with an axially displaceable retainer, the retainer is fixedly mounted within a bore in a housing of one connector component or element. The retainer has a plurality of radially and angularly extending legs which extend inwardly toward the axial center line of the bore in the housing. A tube fitting to be sealingly mounted in the bore in the housing includes a radially upset portion or flange which abuts an inner peripheral surface of the retainer legs. Seal and spacer members as well as a bearing or top hat are typically mounted in the bore ahead of the retainer to form a seal between the housing and the fitting when the fitting is lockingly engaged by the retainer legs in the housing.

Radially displaceable retainers in which the retainer is radially displaceable through aligned bores or apertures formed transversely to the main through bore in the housing are also known. The radially displaceable retainer is typically provided with a pair of depending legs which are sized and positioned to slip behind the radially upset portion or flange on the fitting only when the male fitting or conduit is fully seated in the bore in the housing. This ensures a positive locking engagement of the conduit with the connector as the displaceable retainer can be fully inserted into the connector only when the fitting or conduit has been fully inserted into the bore in the housing.

Regardless of the type of retainer, the housing component portion of a fluid connector typically includes an elongated stem having one or more annular barbs spaced from a first end. The barbs provide secure engagement with a hose or conduit which is forced over the barbs to connect the housing with one end of the conduit.

In an effort to lower hydrocarbon emissions in today's vehicles, vehicle fuel systems are typically provided with a fuel vapor recovery conduit connected between the engine and a fuel vapor recovery canister which receives unburned fuel vapors from the engine vehicle fuel injection system. This fuel vapor conduit, as it is in addition to the fuel conduit itself, represents another conduit which must be coupled at opposite ends to the fuel tank and the vapor canister as well as clipped in mounting positions along the underside of the vehicle. Both of these conduits are typically mounted on the underbody of the vehicle and thereby exposed to rocks or impingement with other objects which could lead to damage and/or rupture.

In addition, considerable effort has been made to prevent permeation of the fuel and/or vapors from fuel or vapor conduits to the atmosphere. This has lead to multiple layer tubes wherein each layer can be formed of a different material to address fuel carrying, permeation, static charge, etc., characteristics.

In a previous attempt to address these deficiencies, a coaxial quick connector was devised which connected first and second separate conduits to third and fourth coaxially disposed conduits. The quick connector in this configuration used slidable retainers to releasably latch the first and second conduits to the connector body. The third and fourth coaxial conduits engaged barbs on the end of the connector housing and a coaxial flow creating insert disposed within the connector.

It would still be desirable to provide a quick connect apparatus which can minimize the number of separate components is a fluid system. It would also be desirable to provide a quick connect apparatus which can be advantageously employed in vehicle fuel systems to minimize permeation of fuel or vapors from vehicle fuel or vapor carrying conduits. It would also be desirable to provide a coaxial quick connect apparatus which facilitates quick assembly of fluid system components.

### SUMMARY

The present invention is a coaxial quick connect apparatus which may be advantageously employed to fluidically couple first and second coaxial conduit assemblies with a single connector body carrying a single retainer. Either or both of the first and second coaxial conduit assemblies may be a coaxial endform on the end of elongated coaxial conduits or an endform on another fluid operative device, such as a fuel sending unit, fuel tank, or other components of the vehicle fuel/vapor system.

In a specific implementation, the insert is in the form of a tubular body having a through bore defining a first outlet flow path from the first port formed at one end of the insert to the second outlet flow path through the third port of the body. A plurality of ribs are carried on the insert for concentrically mounting the insert within the through bore in the body. The insert is sealing coupled to the body to isolate the first outlet flow path from the second outlet flow path.

A retainer is releasably mounted in the connector body to latchingly coupling the first conduit to the body. The retainer can be releasably mounted in a temporary storage position on the connector body for mounting prior to insertion of the first conduit or coaxial endform into the body.

The coaxial quick connector of the present invention uniquely provides a quick connect apparatus which minimizes the number of separate components used to connect multiple components in a fluid flow system. The present coaxial quick connect finds particular advantageous use in a vehicle fuel system where the concentric flow conduits, with liquid fuel disposed to flow through the inner conduit, provides a vapor collection flow path though the outer conduit for vapors permeating through the inner conduit.

### BRIEF DESCRIPTION OF THE DRAWINGS

The various features, advantages and other uses of the present invention will become more apparent by referring to the following detailed description and drawing in which:

FIG. 1 is a longitudinal, partially exploded, partially assembled cross-sectional view through a coaxial quick connector;

FIG. 2 is a perspective view of the assembled quick connector shown in FIG. 1;

FIG. 3 is a perspective view of the insert mounted within the quick connector body;

FIG. 4 is a cross-sectional view generally taken along line 4-4 in FIG. 1;

FIG. 5 is a cross-sectional view generally taken along line 5-5 in FIG. 1;

FIG. 6 is a cross-sectional view generally taken along line 6-6 in FIG. 1;

FIG. 7 is a perspective view of the retainer which is usable in the quick connector shown in FIG. 1;

FIG. 8 is an end view showing the mounting of the retainer depicted in FIG. 7 in a partially inserted, temporary storage position in the quick connector housing;

FIG. 9 is an end view showing the retainer in a fully locked position in the quick connector housing; and

FIG. 10 is a longitudinal, cross-sectional view of the assembled quick connector shown in FIG. 1.

### DETAILED DESCRIPTION OF THE DRAWINGS

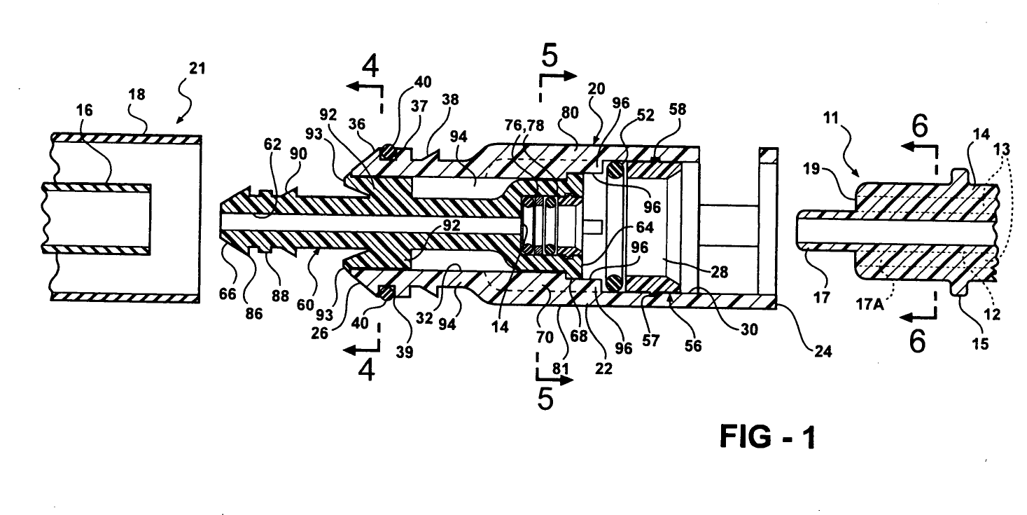

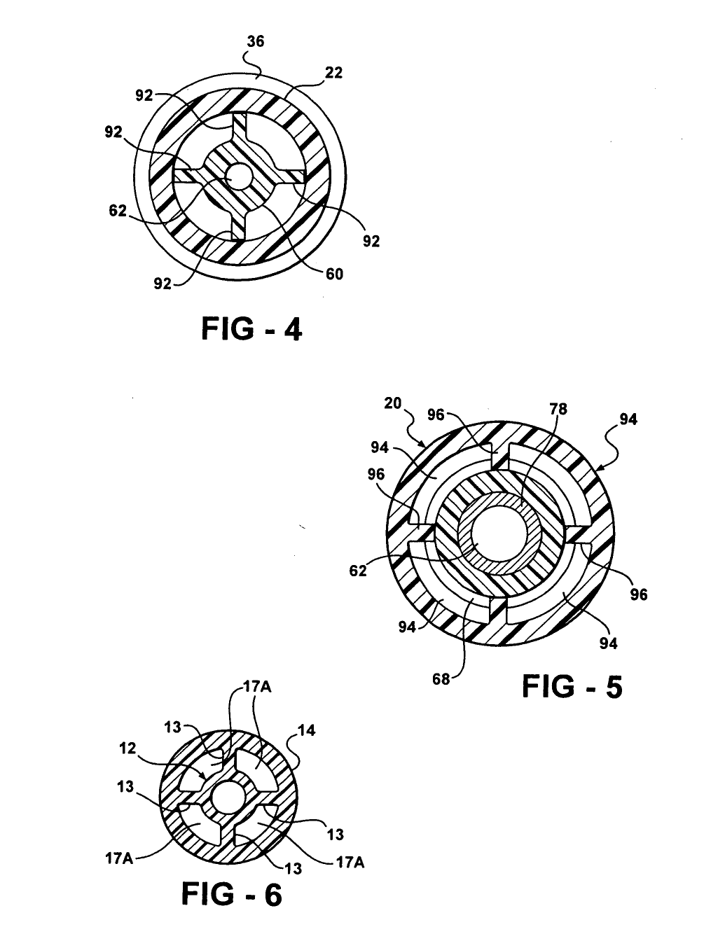

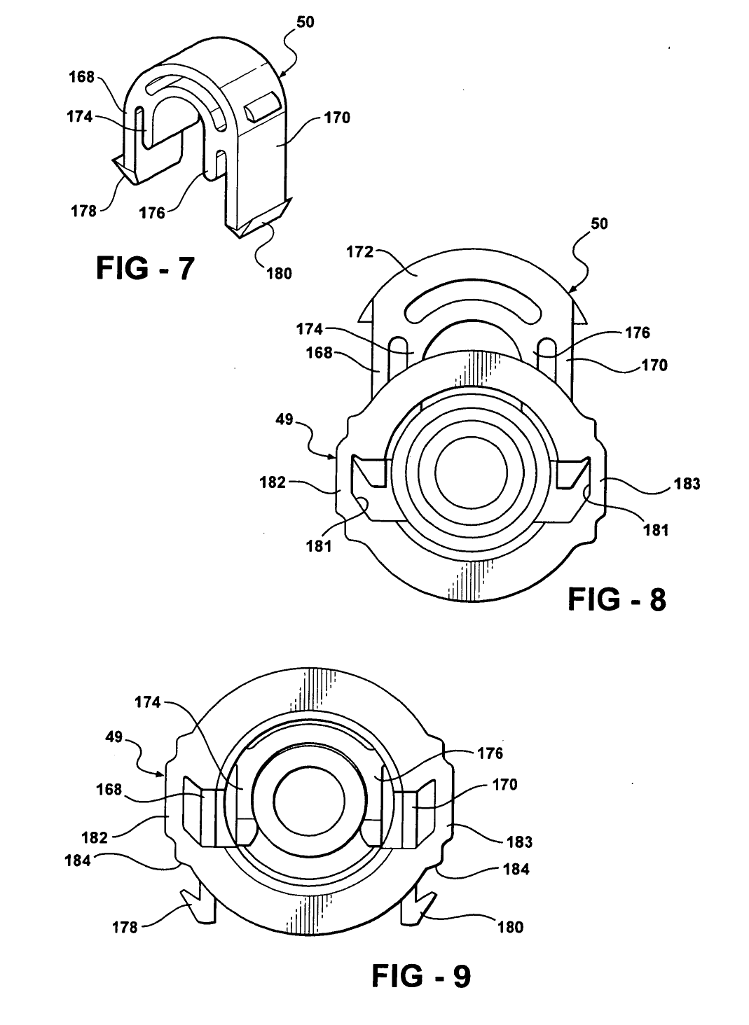

Referring now to FIGS. 1-10 of the drawings, there is depicted a coaxial quick connector 10 operative to fluidically couple first and second concentric, co-axial, conduits 12 and 14, respectively, to concentrically disposed third and fourth conduits 16 and 18, respectively.

The term “conduit” or “conduits” is meant to include any form of tubular member designed to carry fluids, such as liquids, air, etc. The conduits 12, 14, 16 and 18 may be formed of a variety of materials depending upon the particular application in which the coaxial quick connector 10 is used. For example, any or all of the conduits 12, 14, 16 and 18 may be formed of metal, plastic, in either rigid or flexible form, and of different materials. The term “conduits” also includes endforms having a tip end and a profile, such as an annular, enlarged bead or flange or a recessed groove spaced from the tip end.

The term “endform” is meant to include any endform on any tubular conduit, fluid carrying member, fluid operative member, such as a valve, pump, fuel tank, fuel sender unit, vapor canister, etc. The endform may be integrally formed as part of the conduit or fluid device or a separate member sealingly secured to the conduit or fluid device.

Further, although the following description of the operation of the coaxial quick connector 10 designates the first and second conduits 12 and 14 as inlet or input conduits and the third and fourth conduits 16 and 18 as outlet or output conduits, it will be understood that this is by way of example only as the function of the conduits can be reversed, with the third and fourth conduits 16 and 18 acting as inlet conduits and the first and second conduits 12 and 14 acting as outlet conduits for fluid flow through the coaxial quick connector 10.

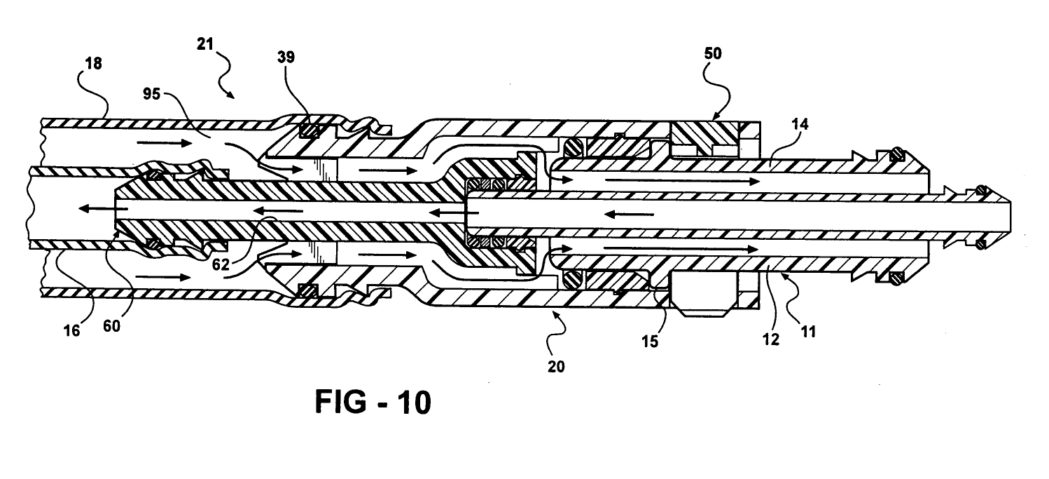

As shown in FIGS. 1 and 10, the first and second conduits 12 and 14, hereafter referred to jointly as an endform 11, can be integrally formed, such as by molding or extrusion, as an integral one-piece assembly. The first conduit 12 is concentrically disposed within the outer positioned, second conduit 14. As shown in FIG. 6, a plurality of longitudinally extending ribs 13, with four ribs 13, shown by way of example, are formed or disposed between the conduits 12 and 14 to space the outer, second conduit 14 concentrically about the first conduit 12. This defines a plurality of flow paths, all denoted by reference number 17A between the first exterior of the conduit 12, the ribs 13 and the interior of the second conduit 14 which extend through the endform 11. As shown in FIG. 1, the inner first conduit 12 has an end portion 17 projecting axially outward from an end 19 of the outer second conduit 14.

Although now shown in FIG. 1, the third and fourth conduits 16 and 18, which are hereafter jointly referred to as an endform 21, are also concentrically disposed by ribs, which may be integrally formed between the third and fourth conduits 16 and 18 or longitudinally spaced along the length of the third and fourth conduit 16 and 18 in the form of one or more spacers.

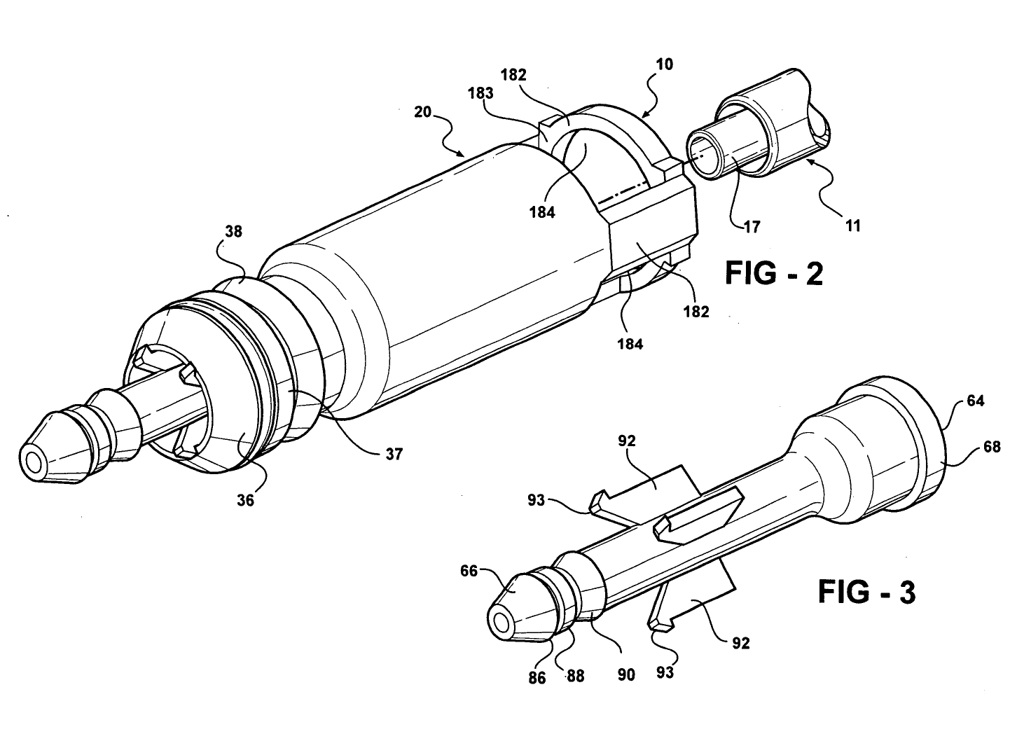

As shown in FIGS. 1 and 2, the coaxial quick connector 10 includes a housing 20. The component parts of the housing 20, as described hereafter, can be integrally and unitarily formed as a one piece body by molding, machining, etc., as shown in FIG. 1, or as separate components which are unitarily joined together by means of welding, adhesives, and/or mechanical fasteners. Thus, in one aspect, the housing 20 is formed as a one-piece body, typically by molding, from any of a variety of different materials, such as glass filled nylon, by example only.

Whether or not the housing 20 is formed of one or more separate components which are sealingly joined together, the housing 20 includes a first generally tubular portion 22 extending from a first end 24. A bore 28 extends between open ends or ports at the first end 24 and a second end 26 of the housing 20. A first end portion of the bore 28 adjacent to and extending axially from the first end 24 of the first tubular portion 22 has a stepped configuration formed of a first, largest diameter bore portion 30, and a second smaller diameter, intermediate bore portion 32. The first and second bore portions 30 and 32 are arranged co-axially from the first end 24 of the first tubular portion 22.

The second end 26 of the first tubular portion 22 includes at least one and, by example, a plurality of annular barbs or tubular retention elements 36, 37 and 38 which are arranged in an axially spaced manner from the second end 26. The retention elements 36, 37 and 38 slidably receive the outer fourth conduit 18 causing a slight radial expansion of the end portion of the fourth conduit 18 to enable the fourth conduit 18 to securely grip and be securely attached to the second end 26 of the first tubular portion 22 of the housing 20.

The annular recess 39 formed between the retention elements 36 and 37 can receive a seal member, such as an O-ring 40, to facilitate sealing engagement between the outer third conduit 16 and the end of the housing 20.

At least one and, by example, a plurality of seal elements, such as an O-ring 52, is mounted in the first bore portion 30. The seal element 52 is fixed in position in the first portion 30 by means of a bushing or top hat 56 which is locked in the first bore portion 30 by engagement of a projection 57 on the top hat 56 with a groove. 58 in the housing 20.

As shown in FIGS. 1, 3, and 10, the coaxial quick connector 10 also includes an insert 60 which is mounted in the first tubular portion 22 concentrically within the first bore portion 30. The insert 60 shown in detail in FIG. 3, defines a first fluid flow path formed by a through bore 62 extending through the insert 60.

The insert 60 includes an open first end or port 64, and an opposed open end 66. The insert 60 is formed of a suitable material, such as a plastic, for example, a glass filled nylon.

An enlargement or shoulder 68 is formed on the first end 64 of the insert 60. A stepped bore portion is formed in the insert 60 includes a first large diameter bore portion 70 extending from the first end 64, and a second bore defining the main through bore 62. A shoulder 74 is formed between the second stepped bore 72 and the through bore 62 and acts as an insertion stop or limit for the second conduit 14 in the bore portion 30.

The second stepped bore 72 has a diameter such that an inner surface of the second stepped bore 70 is spaced from the outer surface of the second conduit 14. Seal elements, such as O-rings 76, and an intermediate spacer 78, for example, are held in the second stepped bore 70 by a top hat 80. The top hat 80 has an outer end flange 81 which snaps into a recess in the insert 60 as shown in FIG. 1.

One or a plurality of annular barbs, such as three barbs 86, 88, and 90, for example, are spaced from the second end 66 to securely grip the inner third conduit 16 as shown in FIG. 10.

At least two and, by example only, three or four ribs 92 are formed on the insert 60 axially spaced from the second end 66. The outer diameter of the ribs 92 is sized to engage the inner surface of the housing 20 adjacent to the second end 26, as shown in FIGS. 1 and 10. The ribs 92 in conjunction with the second end 66 of the insert 60 and the inner surface of the first tubular portion 22 combine to form a plurality of flow channels 94 which merge axially beyond the ribs 92 into a single flow path channel 95 extending over the second end 66 of the insert 60. The flow channel 95, as shown in FIG. 10, is fluidically coupled to a flow path or channel formed between the concentric third and fourth conduits 16 and 18.

A plurality, such as two or more, for example, of ribs 96 are circumferentially spaced in the first bore portion 30 of the housing 20 as shown in FIGS. 1, 5, and 10. The ribs 96 project radially inward from an outer side wall of the housing 20 and have an inner diameter surface which forms a surface of the bore 28 extending through the housing 20. Each rib 96 also has an intermediate notch which receives the enlargement 68 on the insert 60 to axially position the insert 60 in the housing 20. The seal 52 and the top hat 58 are axially mounted in the first bore portion 30 of the bore 28 in-line with the end of the ribs 96.

The flow channels 94 formed by the ribs 92 communicate with similar flow channels 94 formed between the ribs 96 to establish a fluid flow path for fluid from the flow paths 15 formed between the first and second conduits 12 and 14 and the flow path formed between the third and fourth conduits 16 and 18 through the connector 10.

Each rib 92 also has an enlargement 93 which is adapted to engage the outer end 36 of the housing 20 as shown in FIG. 1. The enlargements 93 on the ends of the ribs 92 deflect radially inward during insertion of the insert 60 through the first end 24 of the housing 20 into the bore 28 and then snap radially outward to engage the end 36 of the housing 20 as shown in FIG. 1

The bore 62 in the insert 60 fluidically couples the bore in the first conduit 12 with the bore in the third conduit 18 through the quick connector 10 as shown in FIG. 10.

Before describing the assembly of the coaxial quick connector 10, the construction and mounting of the retainer 50 will first be described.

Further, although the retainer 50 will be described hereafter as being in the form of a transversally mountable retainer, axially operable retainers, such as the retainer shown in U.S. Pat. No. 5,456,500 may also be employed in the coaxial quick connector 10 with only minor modification to the retainer receiving elements of the housing 20 and/or the insert 60.

The retainer 50 is similar to the retainer shown in U.S. Pat. No. 5,730,481 in that it includes a pair of legs 168 and 170 which depend from a central bight portion or end 172. Inwardly extending projections or inner arms 174 and 176 have free ends movably spaced from the adjacent legs 168 and 170. The arms 174 and 176 are dimensioned to slidingly engage and fit around the other portion of the endform 11 only when the endform 11 is fully inserted into the bore 28 of the housing 20. Outwardly extending projections 178 and 180 are formed on the lower portion of each leg 168 and 170 and engage edges or grooves 181 in the sides 182 and 183 of the second tubular portion 49 in a partially inserted, shipping position shown in FIG. 8, or a lower edge 184 on the sides 182 and 183 in the first inserted position shown in FIG. 9 thereby locked in the endform 11 in the enlarged first bore portion 30 of the housing 20.

The side edges of the legs 168 and 170 of the retainer 50 engage one edge of the enlarged bead or flange 15 on the endform 11, as shown in FIG. 10 to latch the endform 11 in the housing 20. At the same time, the arms 174 and 176 still resist full insertion of the retainer 50 into the housing 12 if the endform 11 is not fully inserted into the first bore portion 30 since the enlarged flange 15 will be in an interference position with the arms 174 and 176.

The retainer 50 will remain in the shipping position shown in FIG. 8 during insertion of the first endform 11 into the bore portion 30. Only after the first endform 11 has been fully inserted into the bore portion 30 will the retainer 50 be able to be fully inserted through the transverse apertures 179 in the housing 20.

In use, the coaxial quick connector 10 is prepared for assembly with the first, second, third and fourth conduits 12, 14, 16 and 18, respectively, of the first and second endforms 11 and 21 by first inserting the insert 60 into the bore 28 in the housing 20. The insert 60 can have the seal elements 76 and the spacer 78 as well as the top hat 80 pre-mounted therein or separately mounted in the insert 60 after the insert 60 is fixed in the housing 20. The retainer 50 will be inserted into the temporary, storage position shown in FIG. 8, in the housing 20. The seal elements 52 and 54 and the top hat 56 are also pre-mounted in the first bore portion 30.

The coaxial quick connector 10 can be shipped from the manufacturing facility of the quick connector 10 to an installation facility in this condition or it can have either or both of the endforms 11 and 21 pre-mounted thereon. The third and fourth conduits 16 and 18 can be separate from any fluid device attached to an opposite end or pre-attached to or unitarily formed on the fluid device.

At the final assembly site, unless already pre-mounted, the endform 11 carrying the first and second conduits 12 and 14 is inserted through the open end 24 of the housing 20 until the annular bead or flange 15 is fully inserted into the bore 28 in the housing 20. The retainer 50 is then moved from the temporary storage position shown in FIG. 8 to the fully locked position in FIG. 9.

In a specific application of the coaxial quick connector 10, described by example only, the first conduit 12 is part of a fluid flow path extending from a vehicle fuel tank through the third conduit 16 to the vehicle engine. The second conduit 14 ands the fourth conduit 18 are fluidically coupled by the housing 20 to function as a vapor flow path between the engine and a vapor collection canister, not shown.

As shown in FIG. 10, the second or opposite end of the endform 11 from the end 17 inserted into the housing 20 has barbs or retention elements, similar to the retention elements 36, 37, 38, 86, 88 and 90 on the housing 20 and the insert 60, on the second ends of the inner and outer conduits 12 and 14 for attachment to hose connections on a vehicle fuel tank and/or vapor canister.

As shown in FIG. 1, the sealed connection between the extended end 17 of the first conduit 12 with the seal elements 76 and 78 in the bore at one end of the insert 60 is contained completely and concentrically within the flow path 94 extending between the outer surface of the insert and the inner surface of the connector housing 20. In a specific application where the first and third conduits 12 and 16 are adapted to carry fuel from a vehicle fuel tank to the engine and the second and fourth conduits 14 and 18 are connected between the engine and a vapor collection canister, it can be readily appreciated that any vapors or fuel that may escape from the sealed connection of the end 17 of the first conduit 12 on the endform 11 with the seals 76 and 78 in the bore at one end of the insert 60 is surrounded by and trapped in the vapor flowing through the flow path 94 in the joined connector housing 20 and insert 60. This prevents such escaped fuel or vapors from passing exteriorly out of the connector housing.

In summary, there has been disclosed a unique coaxial quick connector which enables individual conduits, sealingly coupled to a housing, to establish separate flow paths to at least one pair of concentrically disposed, coaxial outlet flow paths through concentrically disposed conduits. In this manner, the need for a pair of discrete outlet conduits, each requiring separate quick connectors, retainers, and mounting clips, are reduced to a single larger, concentric pair of conduits requiring fewer quick connect components and mounting clips. At the same time, when the coaxial quick connector is used with fuel and vapor conduits in a vehicle, the coaxially disposed conduits can be arranged so that liquid fuel flows through the inner conduits and vapor through the outer conduit. In this manner, any out-permeation of vapors from the liquid fuel through the walls of the inner conduits are trapped within the outer conduits thereby minimizing potential out-permeation of fuel vapors to the atmosphere.

What is claimed is:

1. A fluid connector for fluidically connecting first endform
defining first and second flow paths to a second endform having third and fourth flow paths, the connector comprising:
a body defining first and second ends;
a bore extending between the first and second ends; and
an insert carried in the body and defining a plurality of flow paths through a portion of the bore in the body, the insert fluidically coupling the first flow path to the third flow path and the second flow path to the fourth flow path.

2. The connector of claim 1 wherein the insert comprises:
a tubular body having a through bore defining one of the plurality of flow paths.

3. The connector of claim 1 wherein the insert further comprises:
a plurality of circumferentially spaced ribs carried on the insert, the ribs mounting the insert concentrically within the bore of the body.

4. The connector of claim 1 comprising:
a first seal element disposed within the insert for forming a sealed coupling between the first endform and the insert.

5. The connector of claim 1 further comprising:
a second seal element disposed in the bore of the housing for forming a sealed coupling between the first endform and the housing.

6. The connector of claim 1 further comprising:
a retainer carried by the body, the retainer engagable with the first endform to latch the first endform to the body.

7. The connector of claim 6 further comprising:
a latch recess carried in the body adjacent the first end; and
at least one latch member carried on a retainer for releasably latching the retainer in the latch recess in a temporary storage position allowing insertion of the first endform therethrough into the body.

8. The connector of claim 6 further comprising:
opposed apertures formed in the body adjacent the first end for receiving one retainer therethrough; and
the at least latch member on the retainer extendable through at least one of the apertures to latch the retainer in a fully latched position with respect to the housing to couple the first endform to the body.

9. The connector of claim 1 further comprising:
means, carried on the second end of the body, for forming a sealed coupling between the third and fourth flow paths of the second endform to the body.

10. The connector of claim 4 wherein:
the sealed coupling for the first flow path in the first endform through one of the flow paths in the body and the insert to the third flow path in the second endform is concentrically surrounded by a flow path in the body connecting the second and fourth flow paths in the first and second endforms.

11. The connector of claim 1 wherein the first and second flow paths in the first end form are concentric inner and outer flow paths.

12. The connector of claim 1 wherein:
the third and fourth flow paths in the second end form are concentric inner and outer flow paths, respectively.

13. The connector of claim 1 wherein:
an end of the first flow path of the first endform extends longitudinally outward from an end of the second flow path in the first endform.

14. The connector of claim 1 wherein:
an end of the fourth flow path in the second endform extends longitudinally outward from an end of the third flow path of the second endform.

15. A fluid connector fluidically connecting a first endform defining first and second flow paths to a second endform having third and fourth flow paths, the connector comprising:
a body defining first and second ends;
a bore extending between the first and second ends; and
an insert in the form of a tubular member carried in the body, the tubular member having a through bore defining one of the plurality of flow paths through the body and a plurality of circumferentially spaced ribs carried on the tubular member, the ribs mounting the tubular member concentrically within the bore of the body and defining another one of the plurality of flow paths through the body.

16. The quick connector of claim 14 further comprising:
a retainer carried by the body, the retainer engagable with the first endform to latch the first endform to the body.

17. The connector of claim 15 wherein:
a sealed coupling of the first flow path in the first endform through the one flow path in the insert to the third flow path in the second endform is concentrically surrounded by a flow path in the body connecting the second and fourth flow paths in the first and second endforms.

18. The connector of claim 4 further comprising:
a first top hat, mountable in the bore in the insert, the first top hat fixing the first seal element in the insert.

19. The connector of claim 1 further comprising:
a second top hat, fixedly mountable in the bore in the body, the second top hat fixing the second seal element in the bore in the body.

20. The connector of claim 9 further comprising:
radially outward extending barbs carried on the second end of the body, the barbs sealingly engagable with the second endform.

21. The connector of claim 20 wherein:
the second end of the body includes an inner tubular portion projecting longitudinally outward from an end of an outer tubular portion; and
barbs formed on the inner tubular portion and the outer tubular portion.

22. A fluid coupling comprising:
a first endform defining first and second flow paths;
a second endform defining third and fourth flow paths;
a body defining first and second ends;
a bore extending between the first and second ends of the body; and
an insert carried in the body and defining a plurality of flow paths through a portion of the bore in the body, the insert fluidically coupling the first flow path to the third flow path, and the second flow path to the fourth flow path.

23. The connector of claim 17 wherein the insert comprises:
a tubular body having a through bore defining one of the plurality of flow paths.

24. The connector of claim 17 wherein the insert further comprises:
a plurality of circumferentially spaced ribs carried on the insert, the ribs mounting the insert concentrically within the bore of the body.

25. The connector of claim 17 comprising:
a first seal element disposed within the insert for forming a sealed coupling between the first endform and the insert.

26. The connector of claim 17 further comprising:
a second seal element disposed in the bore of the housing for forming a sealed coupling between the first endform and the housing.

27. The connector of claim 17 further comprising:
a retainer carried by the body, the retainer engagable with the first endform to latch the first endform to the body.

28. The connector of claim 27 further comprising:
a latch recess carried in the body adjacent the first end; and
at least one latch member carried on a retainer for releasably latching the retainer in the latch recess in a temporary storage position allowing insertion of the first endform therethrough into the body.

29. The connector of claim 27 further comprising:
opposed apertures formed in the body adjacent the first end for receiving one retainer therethrough; and
the at least latch member on the retainer extendable through at least one of the apertures to latch the retainer in a fully latched position with respect to the housing to couple the first endform to the body.

30. The connector of claim 17 further comprising:
means, carried on the second end of the body, for forming a sealed coupling between the third and fourth flow paths of the second endform to the body.

31. The connector of claim 25 wherein:
the sealed coupling for the first flow path in the first endform through one of the flow paths in the body and the insert to the third flow path in the second endform is concentrically surrounded by a flow path in the body connecting the second and fourth flow paths in the first and second endforms.

32. The connector of claim 17 wherein the first and second flow paths in the first end form are concentric inner and outer flow paths.

33. The connector of claim 17 wherein:
the third and fourth flow paths in the second end form are concentric inner and outer flow paths, respectively.

34. The connector of claim 17 wherein:
an end of the first flow path of the first endform extends longitudinally outward from an end of the second flow path in the first endform.

35. The connector of claim 17 wherein:
an end of the fourth flow path in the second endform extends longitudinally outward from an end of the third flow path of the second endform.

36. The connector of claim 4 further comprising:
a first top hat, mountable in the bore in the insert, the first top hat fixing the first seal element in the insert.

37. The connector of claim 17 further comprising:
a second top hat, fixedly mountable in the bore in the body, the second top hat fixing the second seal element in the bore in the body.

38. The connector of claim 30 further comprising:
radially outward extending barbs carried on the second end of the body, the barbs sealingly engagable with the second endform.

39. The connector of claim 38 wherein:
the second end of the body includes an inner tubular portion projecting longitudinally outward from an end of an outer tubular portion; and
barbs formed on the inner tubular portion and the outer tubular portion.
